(19) United States
(12) Patent Application Publication
(10) Pub. No.: US 2026/0002390 A1
(43) Pub. Date: Jan. 1, 2026

(54) MOTOR VEHICLE LOCK

(71) Applicant: Kiekert Aktiengesellschaft, Heiligenhaus (DE)

(72) Inventors: Holger SCHIFFER, Meerbusch (DE); Peter SZEGENY, Engelskirchen (DE); Thomas SCHÖNENBERG, Burscheid (DE); Ömer INAN, Dorsten (DE); Michael SCHOLZ, Essen (DE)

(73) Assignee: Kiekert Aktiengesellschaft, Heiligenhaus (DE)

(21) Appl. No.: 18/992,224

(22) PCT Filed: Jun. 5, 2023
(86) PCT No.: PCT/DE2023/100427

§ 371 Date: Jan. 21, 2025

(30) Foreign Application Priority Data
Jul. 11, 2022 (DE) 10 2022 117 167.1

(51) Int. Cl. E05B 81/90; E05B 79/20; E05B 81/06; E05B 81/14; E05B 81/46

(52) U.S. Cl. CPC E05B 81/90; E05B 79/20; E05B 81/06; E05B 81/14; E05B 81/46

(57) ABSTRACT

The invention relates to a motor vehicle latch, in particular a motor vehicle door latch, which is equipped with a locking mechanism (1, 2) substantially comprising a catch (1) and a pawl (2). An operating lever chain (3, 4, 5, 6, 7) is also provided, comprising an associated door handle (7) and an electromotive drive (9, 10, 11). As the invention also relates to a securing unit (5, 6; 12, 13), wherein the electromotive drive (9, 10, 11) acts on both the locking mechanism (1, 2) for the purpose of electrical opening and on the securing unit (5, 6; 12, 13), and at least temporarily acts upon same during the electrical opening. According to the invention, the locking mechanism (1, 2) can be opened via a two-stroke operation of the door handle (7) in addition to the electromotive drive (9, 10, 11), wherein the two-stroke operation is disabled during the electrical opening.

The invention relates to a motor vehicle latch, in particular a motor vehicle door latch, with a locking mechanism consisting substantially of a catch and a pawl, furthermore with an operating lever chain with an associated door handle and with an electromotive drive, and with a securing unit, wherein the electromotive drive operates both on the locking mechanism for electrical opening and on the securing unit and acts on the latter (the securing unit) at least temporarily during electrical opening.

The motor vehicle latch is preferably a motor vehicle door latch, although the aforementioned motor vehicle latch does not necessarily have to be used in connection with or on a motor vehicle door. In principle, other applications in or on the motor vehicle are also conceivable, for example in conjunction with a motor vehicle flap or similar. With such motor vehicle latches, and motor vehicle door latches in particular, the aim is always to equip the electromotive drive that is often used with as many functions as possible. This can be attributed to the fact that electromotive drives are typically structured in a cost-intensive manner.

For example, the prior art according to WO 2019/076399 A1 proceeds in such a manner that the electromotive drive is equipped with a drive element which operates directly or indirectly on the locking mechanism. In addition, the drive element interacts with at least one further element in a position-dependent manner, wherein the further element is a coupling element of an additionally realized mechanical operating lever chain. This already provides a compact, cost-effective and functional structure.

In the further prior art according to WO 2021/115537 A1, it is possible to lock and unlock or open the locking mechanism simultaneously with the aid of the drive unit or the electromotive drive. The locking unit is usually used to prevent the locking mechanism from being opened manually. This provides a motor vehicle latch with a simplified structure and a small number of components. In addition, a cost-effective and structurally simple solution is realized.

In the prior art according to the unpublished patent application DE 10 2021 128 868 used to form the genus, the procedure is such that the unsecured securing unit is at least temporarily secured by means of a control member which interacts with the electromotive drive. This is done in the opening direction of the electromotive drive. In the opposite opening direction of the drive, the securing unit is transferred to either the secured or unsecured positions.

The entire and previously considered prior art has basically proven itself. This is because the securing unit assuming the “secured” position, in particular, at least temporarily during electrical or electromotive opening ensures that the door handle is not acted upon in relation to the locking mechanism. As a result, there are no collisions or functional impairments between the electromotive drive and the operating lever chain and indifferent functional positions of the operating lever mechanism or the operating lever chain are not observed.

However, problems can arise with the known procedure if the electromotive drive is defective or has failed. In such a case, an associated motor vehicle door or flap cannot be opened or can only be opened with additional equipment. The invention as a whole seeks to remedy this.

The invention is based on the technical problem of further developing such a motor vehicle latch and in particular a motor vehicle door latch in such a manner that emergency operation is also possible and in particular manual aperture of an associated door or flap is made available.

To solve this technical problem, a generic motor vehicle latch and, in particular, a motor vehicle door latch within the scope of the invention is characterized in that the locking mechanism can be opened by two-stroke operation of the door handle in addition to the electromotive drive, wherein the two-stroke operation is deactivated or ineffective during electrical or electromotive opening.

This means that, according to the invention, the motor vehicle latch described and, in particular, the motor vehicle door latch can typically and generally be opened by an electric motor or electrically. This is ensured by the electromotive drive, which works directly or indirectly on the pawl as part of the locking mechanism. This lifts the pawl from its ratcheting engagement with the catch. The catch usually opens spring-assisted and releases a previously trapped locking pin. The associated motor vehicle door can be opened.

In the event that the electromotive drive fails because it has a defect, the associated battery voltage is too low or in connection with an accident, the motor vehicle latch according to the invention can now also be opened manually. This is done via a two-stroke operation of the door handle, even if the electromotive drive has failed. This two-stroke operation is typically carried out in the sense of a so-called “override.” This means that additional unlocking of the associated motor vehicle latch is generally not required. Rather, the two-stroke operation takes place in such a manner that during a first stroke of the door handle a clutch or a clutch element is closed, so that during a further second stroke of the door handle the operating lever chain, which is also closed as a result, can be acted upon via the closed clutch element in such a manner that the pawl is again lifted from its ratcheting engagement with the catch. This allows the locking mechanism to be opened manually, independently of the electromotive drive.

In this context, the two-stroke operation ensures that an accidental and possibly unintentional action upon the door handle, for example, does not lead directly to the door opening. Rather, manual door opening requires deliberate and double operation in the sense of two-stroke operation.

To ensure that action upon the door handle, for example during electric or electromotive opening, does not lead to a collision between the operating lever chain with the door handle at the end on the one hand and the electromotive drive or the locking mechanism acted upon thereby on the other hand, it is additionally provided according to the invention that the two-stroke operation is deactivated during electric opening. This means that the door handle can always be acted upon during the electric opening process, without the locking mechanism being opened at this point. This is because the two-stroke operation cannot be realized during the electric opening process. The fact that the securing unit is typically in its “secured” state during electrical or electromotive opening also contributes to this. As a result, the operating lever chain is also interrupted and the previously mentioned clutch element cannot be transferred to its state in which the operating lever chain is closed.

In this manner, any mechanical collisions between the operating lever chain on the one hand and the electromotive drive and the locking mechanism acted upon hereby on the other are avoided in principle and from the outset. At the same time, proper functioning is ensured because the typically “secured” and only temporarily “unsecured” securing unit ensures that the operating lever chain is interrupted during electrical opening and, in addition, the two-stroke operation is designed so that the door handle can be acted upon, but not in the sense of a two-stroke operation to close the operating lever chain in order to open the locking mechanism. All of this is achieved with a functionally reliable, simple and cost-effective structure. These are the main advantages.

According to an advantageous embodiment, an at least two-part coupling element is arranged between the electromotive drive and the door handle. In most cases, the at least two-part clutch element consists of a first clutch lever of the clutch element and a second clutch lever of the clutch element. The first clutch lever of the clutch element is usually connected directly or indirectly to the door handle. In the case of an indirect connection to the door handle, the first clutch lever and the relevant door handle could, for example, be coupled together in an articulated manner. In most cases, however, a rigid or flexible connecting means is provided between the first clutch lever and the door handle. The flexible connecting element is usually a Bowden cable. This indirectly connects the first clutch lever in question to the door handle. In contrast, the further second clutch lever of the clutch element is connected to a transmission lever that interacts with the electromotive drive.

The invention proposes two basic procedures for connecting the two clutch levers. In a first variant, both clutch levers are coupled or interact with one another via a control contour that moves along a guide track. The control contour can be provided on the second clutch lever, which is connected to the transmission lever.

In a further second variant, the invention proposes that both clutch levers interact with one another via an additional third clutch lever. This third clutch lever is in turn connected to the second clutch lever, usually in an articulated manner.

Since the second clutch lever of the clutch element is acted upon by means of the transmission lever, which in turn interacts with the electromotive drive, the design is also such that the transmission lever is equipped with at least a first and a second transmission contour. The first transmission contour is designed in such a manner that it acts on the second clutch lever. The second transmission contour of the transmission lever, on the other hand, is acted upon by a control member. The control member in turn interacts with the electromotive drive, as will be explained in more detail below with reference to the figure description.

In the context of the invention, the (two-part) coupling element arranged between the electromotive drive and the door handle functions not only as a securing unit or constitutes a component thereof. At the same time, it can be used to set, engage and disengage the two-stroke operation of the door handle effectively and ineffectively.

The electromotive drive is then still advantageous and is usually equipped with a return spring acting on one side. This return spring ensures that the electromotive drive is moved back to its starting position with its help, especially when reversing after an electromotive opening process. Finally, it has proven to be particularly advantageous if the operating lever chain is designed as an inside operating lever chain and the door handle as an inside door handle. In this manner, the motor vehicle latch according to the invention can be regularly opened electrically or by an electric motor, both from the inside and from the outside. Mechanical redundancy is typically and advantageously only realized via internal operation. Of course, it is also within the scope of the invention to realize the mechanical redundancy alternatively via an external operation. Mechanical redundancy via internal operation as well as external operation is also possible. In all these cases, however, this requires the previously described two-stroke operation of the door handle in question.

In this manner, the overall procedure is such that action upon the door handle or an additionally provided outer door handle for electrical opening corresponds first of all and as is generally usual to a switch assigned to the door handle or outer door handle or generally a sensor being acted upon. The sensor operation corresponds to the electromotive drive starting up and lifting the pawl from its ratcheting engagement with the catch in the course of electrical opening. During this process, the securing unit is at least temporarily acted upon during electrical opening and generally returns to its original position after electrical opening.

If the securing unit is in its “unsecured” functional state before electrical opening, the securing unit is at least temporarily transferred to its “secured” position during electrical opening, which corresponds to an interrupted operating lever chain. This means that any action upon the door handle during electric opening is eliminated. Once the electrical opening process is complete, the securing unit returns to its original functional position “unsecured” in connection with the temporary assumption of the “secured” position.

After electromotive opening, the electromotive drive is usually reversed. During reversing, a clutch engaged in connection with the operation of the door handle or any closed state of the clutch element is canceled. As a result, the two-stroke operation of the door handle is designed in such a manner that the locking mechanism cannot be opened manually.

Once the electric opening process is complete, the electromotive drive is reversed. The securing unit is returned to the “unsecured” starting position described in the example. The coupling element is closed in such a manner that the locking mechanism can be opened via the two-stroke operation of the door handle once the electric opening process is complete.

The return spring assigned to the electromotive drive ensures that the electromotive drive reverses beyond the starting position back toward the starting position. The electromotive drive is now back in its starting position. If the electromotive drive fails in this starting position, the locking mechanism can now be opened manually using the described two-stroke operation of the door handle. This works regardless of the position of the securing unit, whether it is “unsecured” or “secured.” This is because with the two-stroke operation, the securing unit is skipped by the “override,” as it were. These are the main advantages.

The invention is explained in greater detail below with reference to drawings which show only one exemplary embodiment. In the drawings:

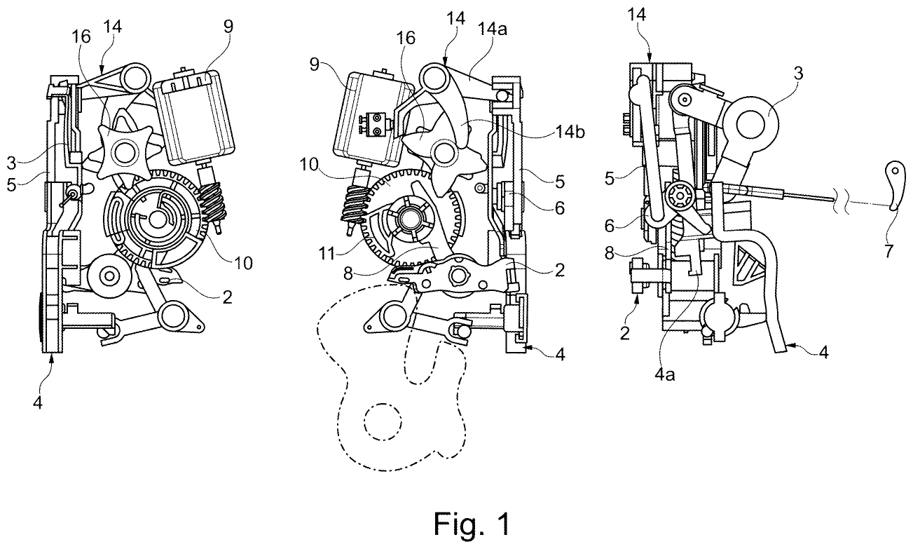

FIGS. 1 to 8 show the motor vehicle latch in a first variant in different functional positions and

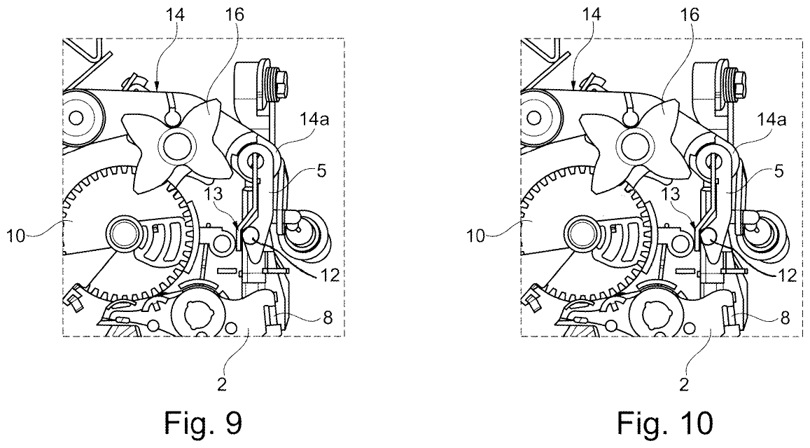

FIGS. 9 to 12 show a further second variant, also in different functional positions.

The figures show a motor vehicle latch which has a locking mechanism 1, 2 consisting of a catch 1 and a pawl 2. The locking mechanism 1, 2 is only shown in full in FIG. 1. In addition, an operating lever chain 3, 4, 5, 6, 7 is realized, which according to the exemplary embodiment is designed as an internal operating lever chain 3, 4, 5, 6, 7. Furthermore, a release lever 8 can be seen, which is used for the electrical or electromotive release of the pawl 2.

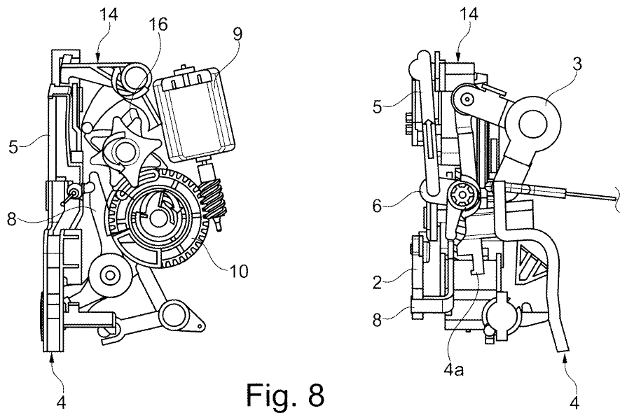

According to the exemplary embodiment, the operating lever chain 3, 4, 5, 6, 7 is composed of an operating lever or interior operating lever 3 and a door handle 7 acting on the operating lever or interior operating lever 3, which, according to the exemplary embodiment, is an interior door handle 7. In addition, the operating lever chain 3, 4, 5, 6, 7 includes a first clutch lever 4 and a second clutch lever 5. Within the framework of the variant according to FIGS. 1 to 8, a further third clutch lever 6 is then realized and provided, which is not included in the exemplary embodiment according to FIGS. 8 to 12.

Both variants have an electromotive drive 9, 10, 11 in common, which according to the exemplary embodiment is equipped with an electric motor 9, with the help of which a worm wheel 10 can be set in rotation. In addition, an operating contour 11 can be seen on the worm wheel 10, which in the context of the exemplary embodiment serves to act on the release lever 8 and overall to ensure the electrical or electromotive opening of the locking mechanism 1, 2, as will be explained in more detail below.

The further basic structure also includes a securing unit 5, 6, which, according to the exemplary embodiment in FIGS. 1 to 8, consists of the second clutch lever 5 and the third clutch lever 6. In the embodiment variant shown in FIGS. 9 to 12, the function of the third clutch lever 6 is ultimately performed by a control contour 12, which can be moved along a fixed guide track 13. In this case, the control contour 12 on the second clutch lever 5 and the fixed guide track 13 therefore take over the alternative function of the securing unit 5, 6 and 12, 13 respectively.

The overall design is such that the electromotive drive 9, 10, 11 operates both on the locking mechanism 1, 2 for electrical opening and on the securing unit 5, 6; 12, 13 and acts at least temporarily on the securing unit 5, 6; 12, 13 in question during electrical or electromotive opening.

In accordance with the invention and of particular importance is the fact that the locking mechanism 1, 2 can be opened by two-stroke operation of the door handle 7 in addition to the electromotive drive 9, 10, 11. This two-stroke operation is deactivated or ineffective during electrical opening. In fact, the two-stroke operation of the door handle 7 results in the fact that, starting from the basic position as shown in FIG. 1, the operating lever or internal operating lever 3 there is pivoted counterclockwise about its axis when the door handle 7 is acted upon, thereby moving the first clutch lever 4 in the right-hand part of FIG. 1 downward.

For this purpose, the first clutch lever 4 of the clutch element 4, 5, 6 is indirectly connected to the door handle 7 according to the exemplary embodiment. According to the exemplary embodiment, the indirect connection is implemented via a Bowden cable, with the help of which the door handle 7 operates on the first clutch lever 4. In principle, however, the door handle 7 can also be directly connected to the first clutch lever 4, although this is not shown.

If the securing unit 5, 6 there is not in the “secured” or “childproof lock on” state shown in FIG. 1, because the securing unit 5, 6 is a childproof lock according to the exemplary embodiment, the locking mechanism 1, 2 can now be opened in a second stroke of the door handle or inner door handle 7. However, this presupposes that the securing unit 5, 6, which is in the “secured” or “childproof lock on” position in FIG. 1, assumes its “unsecured” or “childproof lock off” position. The functional state shown in FIG. 8 corresponds to this.

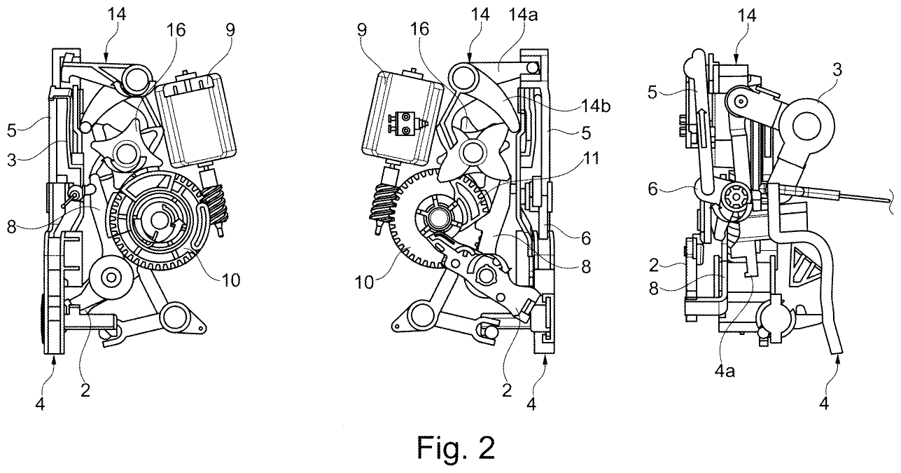

Since in the “unsecured” position of the securing unit 5, 6 the third clutch lever 6 has been pivoted clockwise around its axis during the transition from FIG. 1 to FIG. 8, the first clutch lever 4 can now be brought into engagement with the pawl 2 with its release contour 4a during the first stroke of the door handle 7. A second stroke of the door handle 7 now corresponds in the middle representation of FIG. 1 to the pawl 2 being pivoted clockwise via the release contour 4a, thereby releasing the catch 1. This can be seen in a comparable manner in the transition from FIG. 1 to FIG. 2, where, however, an electrical opening process is shown instead of a manual opening process of the locking mechanism 1, 2.

The mode of operation is as follows. As already explained, the motor vehicle latch according to the invention is in its basic position in FIG. 1. The same applies to the electromotive drive 9, 10, 11 or the worm wheel 10. Two-stroke operation is always engaged or possible. The securing unit 5, 6 is in its “secured” functional position because the third clutch lever 6 ensures that when the door handle 7 is acted upon, the release contour 4a moves past the pawl 2 and cannot act on it.

In the transition from FIG. 1 to FIG. 2, an electric or electromotive opening process can now be traced. This corresponds to the fact that an outside door handle not explicitly shown in the exemplary embodiment acts on a sensor or switch, which in turn is queried with the help of a control unit not shown. The sensor operation causes the control unit to act on the electric motor 9 so that it acts on the worm wheel 10 in a counterclockwise direction during the transition from FIG. 1 to FIG. 2 in the central representation. As a result, the operating contour 11 moves against the release lever 8 at the front of the worm wheel 10 and, via the release lever 8, ensures that the pawl 2 pivots clockwise during the transition from FIG. 1 to FIG. 2. The clockwise movement of the pawl 2 now corresponds to the pawl 2 leaving its ratchet with the catch 1 in the closed state of the locking mechanism 1, 2 shown in FIG. 1. As a result, the catch 1 opens spring-assisted in the sense of a swivel movement around its axis in a clockwise direction and releases a previously trapped locking pin. The corresponding door can be opened.

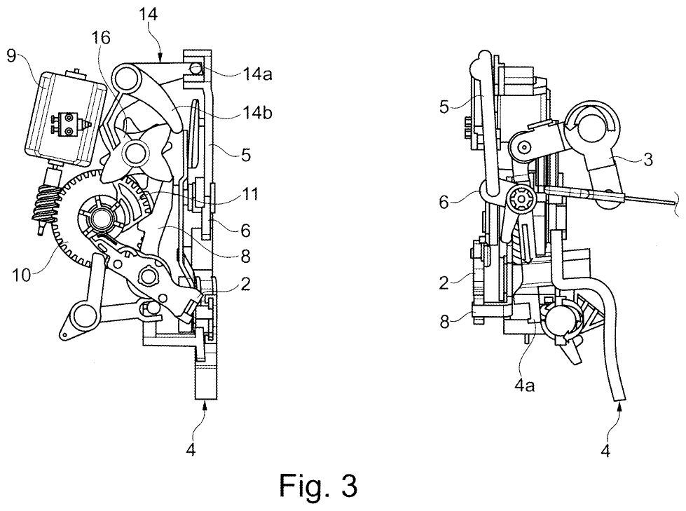

If the door handle 7 is acted upon during the described electrical opening process, as shown in FIG. 3, this causes the first clutch lever 4 to move downward. At the same time, the securing unit 5, 6 has at least temporarily assumed its “unsecured” functional position from the “secured” position as shown in FIG. 1. This can be attributed to the fact that the counterclockwise rotation of the worm wheel 10 for electromotive opening is accompanied by a counterclockwise swivel movement of a transmission lever 14 during the transition from FIG. 1 via FIG. 2 to FIG. 3. For this purpose, the transmission lever 14 is equipped with a first transmission contour 14a and a second transmission contour 14b. The first transmission contour 14a acts on the second clutch lever 5.

In fact, the counterclockwise movement of the transmission lever 14 in connection with the electrical opening process of the locking mechanism 1, 2 during the transition from FIG. 1 via FIG. 2 to FIG. 3 corresponds to said second clutch lever 5 being moved “upward,” so that in this manner the third clutch lever 6, which is connected to the second clutch lever 5 in an articulated manner, pivots about its axis in a clockwise direction. This allows the first clutch lever 4, which according to the exemplary embodiment is connected on the one hand to the door handle 7 and on the other hand in an articulated manner to the operating lever 3 or internal operating lever 3, to be pivoted or moved with its release contour 4a in the direction of the pawl 2. However, since the first clutch lever 4 is not guided by the third clutch lever 6, the two-stroke operation is deactivated as a whole. This means that the release contour 4a of the first clutch lever 4 cannot interact with the pawl 2 and lift it away from its engagement with the catch 1.

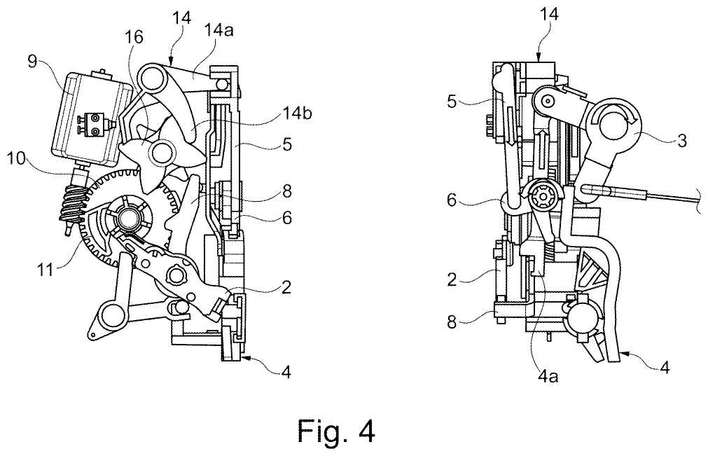

Moving further from FIG. 3 to FIG. 4, the worm wheel 10 is reversed at this transition. This is because in FIG. 3 the pawl 2 is lifted by an electric motor from its engagement with the catch 1 and the desired electrical opening occurs. In connection with this, the electromotive drive 9, 10, 11 is now reversed. This corresponds to a clockwise swivel movement of the worm wheel 10 during the transition from FIG. 3 to FIG. 4. At the same time, the operating contour 11 leaves the release lever 8. The securing unit 5, 6 is in its temporary position “unsecured” or “childproof lock off,” as also shown in FIG. 8, and is in fact temporary. Since the two-stroke operation is also deactivated during the electric opening process, the locking mechanism 1, 2 cannot operate manually on the locking mechanism 1, 2 by acting on the door handle 7 during this electric or motorized opening process. This therefore remains unaffected.

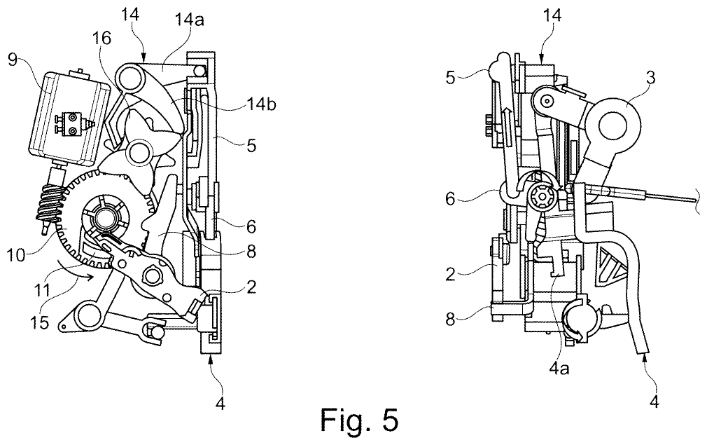

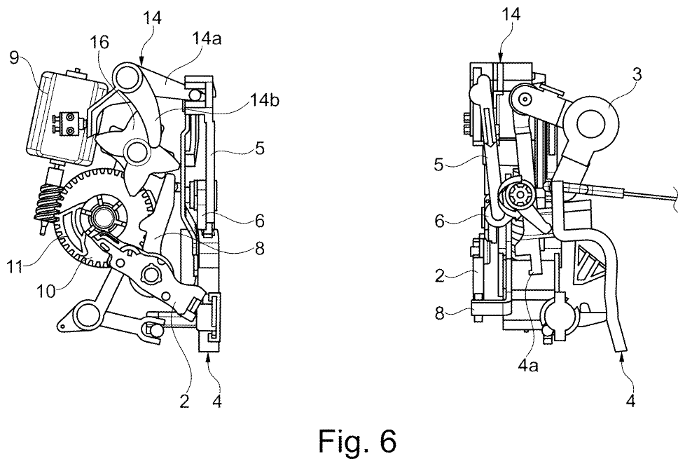

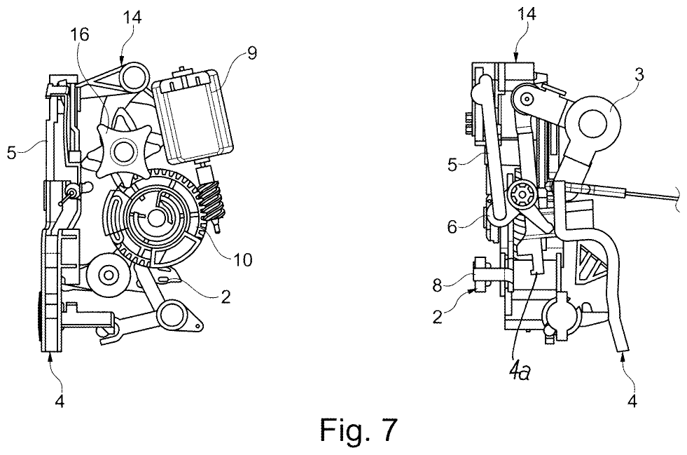

In the transition from FIG. 4 to FIG. 5 and further to FIG. 6, it can be seen that the worm wheel 10 has been reversed beyond the starting position as shown in the representation in FIG. 1. This tensions a return spring 15 assigned to the worm wheel 10 and only indicated at this point, which, in connection with FIG. 6, ensures that the worm wheel 10 is returned to its starting position as shown in the representation in FIG. 1. At the same time, during the transition from FIG. 5 to FIG. 6, the securing unit 5, 6 returns to its original position of “secured” or “childproof lock on.” This corresponds to the fact that the third clutch lever 6 can interact with the first clutch lever 4, as can also be seen in the representation in FIG. 7. As a result, the first clutch lever 4 cannot be moved with its release contour 4a in the direction of the pawl 2 and is consequently unable to interact with the pawl 2 or to lift it away from its engagement with the catch 1. This is only possible by overriding the securing unit 5, 6 or the third clutch lever 6.

As already explained, the transmission lever 14 is equipped with at least the first transmission contour 14a and the second transmission contour 14b. The first transmission contour 14a acts on the second clutch lever 5, while the second transmission contour 14b is acted upon by a control member 16. The control member 16 is designed with multiple arms for this purpose and is acted upon by a further contour, not explicitly shown, on the rear side of the worm wheel 10 of the electromotive drive 9, 10, 11.

FIGS. 9 to 12 now show a modified embodiment. The transmission lever 14 and the control member 16 operating on the transmission lever 14 can be recognized. The transmission lever 14 works with the first transmission contour 14a on the second clutch lever 5. The second clutch lever 5 is equipped with the control contour 12, which can interact with the stationary guide track 13 or can be moved along the guide track 13.

FIG. 9 shows the securing unit 12, 13 formed in this manner in the “secured” state. In addition, the two-stroke operation is engaged in this case. FIG. 10 again shows the “secured” state of the securing unit 12, 13, this time with two-stroke operation. In both cases, the securing unit 12, 13 ensures that the pawl 2 as a whole cannot be lifted from its ratcheting engagement with the catch 1 when the operating lever 3 is acted upon using the door handle 7.

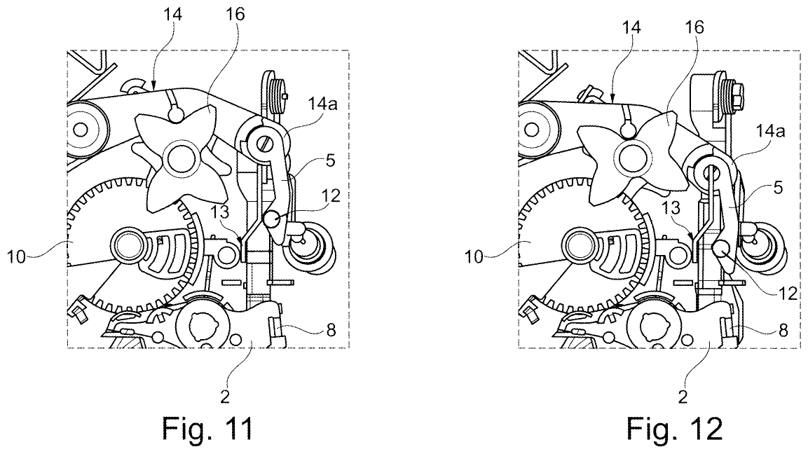

If, on the other hand, the securing unit 12, 13 is deactivated or is in its “unsecured” or “childproof lock off” state as shown in the representation in FIGS. 11 and 12, the first clutch lever 4 can operate on the pawl 2 via the operating lever 3 when the door handle 7 is acted upon and lift it from its ratcheting engagement with the catch 1. In this case, the second clutch lever 5 rests against the side of the first clutch lever 4. Consequently, during a first stroke of the door handle 7 (in connection with an electrical opening process), the first clutch lever 4 can collapse overall in relation to the pawl 2, so that during the second stroke of the door handle 7, the pawl 2 is ultimately lifted from its engagement with the catch 1 and the locking mechanism 1, 2 is thus opened manually.

### LIST OF REFERENCE SIGNS

1 catch
2 pawl
1,2 locking mechanism
3 operating lever or internal operating lever
4 first clutch lever
4a release contour
5 second clutch lever
6 third clutch lever
7 door handle
3, 4, 5, 6, 7 operating lever chain
8 release lever
9 electric motor
10 worm wheel
11 operating contour
9, 10, 11 electromotive drive
12 control contour
13 guide track
5, 6; 12, 13 securing unit
14 transmission lever
14a first transmission contour
14b second transmission contour
15 return spring
16 control member

1. A motor vehicle latch comprising:
a locking mechanism including: a catch and a pawl,
an operating lever chain including door handle,
an electromotive drive, and
a securing unit,
wherein the electromotive drive is configured to operate both on the locking mechanism and at least temporarily on the securing unit during an electrical opening,
wherein the locking mechanism is configured to be opened by a two-stroke operation of the door handle, and
wherein the two-stroke operation is configured to be deactivated during the electrical opening.

2. The motor vehicle latch according to claim 1 further comprising an at least two-part clutch element including a first clutch lever and a second clutch lever, wherein the at least two-part clutch element is arranged between the electromotive drive and the door handle.

3. The motor vehicle latch according to claim 2, wherein the first clutch lever of the at least two-part clutch element is operably connected to the door handle.

4. The motor vehicle latch according to claim 2, further comprising a transmission lever configured to interact with the electromotive drive, wherein the second clutch lever of the at least two-part clutch element is operably connected to the transmission lever.

5. The motor vehicle latch according to claim 3, further comprising a guide track and a control contour configured to move along the guide track, wherein the first and second clutch levers are operably connected via the control contour.

6. The motor vehicle latch according to claim 2, wherein the at least two-part clutch includes a third clutch lever, and wherein the first and second clutch levers are operably connected via the third clutch lever.

7. The motor vehicle latch according to claim 4 further comprising a control member,
wherein the transmission lever includes a first transmission contour and a second transmission contour, and
wherein the first transmission contour acts on the second clutch lever and the control member acts on the second transmission contour.

8. The motor vehicle latch according to claim 7, wherein the electromotive drive is configured to interact with the control member.

9. The motor vehicle latch according to claim 1, wherein the electromotive drive includes a return spring acting on one side of the electromotive drive.

10. The motor vehicle latch according to claim 1, wherein the operating lever chain is an inside operating lever chain and the door handle is an inside door handle.

11. The motor vehicle latch according to claim 9, wherein the return spring is configured to reverse the electromotive drive beyond a starting position back toward the staring position.

12. The motor vehicle latch according to claim 1, wherein the operating lever chain is an external operating lever chain and the door handle is an external door handle.

13. The motor vehicle latch according to claim 1, wherein the securing unit in an unsecured functional state is configured to temporarily transfer to a secured position during the electrical opening and return to the unsecured functional state when the electrical opening is complete.

14. The motor vehicle latch according to claim 1, wherein the two-stroke operation of the door handle is configured to override the securing unit to manually open the locking mechanism when the electromotive drive fails.

15. The motor vehicle latch according to claim 3, wherein the first clutch lever is indirectly connected to the door handle via a Bowden cable.

16. The motor vehicle latch according to claim 7, wherein control member includes multiple arms that each acts on a respective contour from among the first transmission contour and the second transmission contour.
